(19) United States
(12) Patent Application Publication
(10) Pub. No.: US 2026/0051041 A1
(43) Pub. Date: Feb. 19, 2026

(54) IMAGE-BASED FOREIGN OBJECT DETECTION APPARATUS AND AN OPERATING METHOD THEREOF IN WIRELESS CHARGING SYSTEM

(71) Applicant: ELECTRONICS AND TELECOMMUNICATIONS RESEARCH INSTITUTE, Daejeon (KR)

(72) Inventors: Gwangzeen KO, Daejeon (KR); Seong-Min KIM, Daejeon (KR); Kyeseok YOON, Daejeon (KR); In Kui CHO, Daejeon (KR)

(73) Assignee: ELECTRONICS AND TELECOMMUNICATIONS RESEARCH INSTITUTE, Daejeon (KR)

(21) Appl. No.: 19/298,523

(22) Filed: Aug. 13, 2025

(30) Foreign Application Priority Data
Aug. 14, 2024 (KR) 10-2024-0108853

(51) Int. Cl. G06T 7/00; G06T 5/50; H02J 50/60

(52) U.S. Cl. CPC G06T 7/0008; G06T 5/50; G06T 7/97; H02J 50/60; G06T 2207/20028; G06T 2207/20032; G06T 2207/20224; G06T 2207/30232

(57) ABSTRACT

An apparatus for detecting foreign objects based on an image in a wireless charging system is provided. The apparatus includes an image capturing device configured to photograph a charging region of the wireless charging system to previously obtain a normal image including no foreign object and photograph the charging region to a current image of a current frame and an image processing device configured to generate a difference image between the normal image and the current image, remove reflected light in the current image, and detect whether a foreign object is in the charging region, based on the difference image and a reflected light-removed current image.

### CROSS-REFERENCE TO RELATED APPLICATIONS

This application claims the benefit of the Korean Patent Application No. 10-2024-0108853 filed on Aug. 14, 2024, which is hereby incorporated by reference as if fully set forth herein.

### BACKGROUND

### Field of the Invention

The present disclosure relates to an apparatus and method of detecting foreign objects in a wireless charging system, and more particularly, to a foreign object detection apparatus and an operating method thereof, which may capture a charging region between a transmitting coil and a receiving coil in a wireless charging system to obtain an image and may detect a foreign object, based on the obtained image.

### Discussion of the Related Art

FIGS. 1 and 2 are diagrams for describing a wireless charging system of the related art.

The wireless charging system may be operated for wirelessly charging a battery of a special-purpose robot 10 of FIG. 1 or a battery of an electric vehicle 20 of FIG. 2.

In the robot 10 of FIG. 1, the wireless charging system is configured in a structure where a transmitting coil 11 installed in a direction facing a side surface of the robot 10 wirelessly supplies power to a receiving coil 12 installed on the side surface of the robot 10. Similarly, in the electric vehicle 20 of FIG. 2, the wireless charging system is configured in a structure where the transmitting coil 21 installed on a bottom thereof wirelessly transmits power to the receiving coil 22 installed on a lower surface of the electric vehicle 20.

A space between the transmitting coil 11 or 21 and the receiving coil 12 or 22 is referred to as a charging region 13 or 23, and when a foreign object such as metal or a living thing penetrates into the charging region 13 or 23, a degradation in wireless charging performance and a risk situation such as fire may occur. Therefore, when a foreign object is detected in the charging region 13 or 23, the transmission of power from the transmitting coil to the receiving coil should be cut off.

In a method of detecting a foreign object in the charging region 13 or 23, there may be a method which photographs a charging region to obtain an image by using an image capturing device 30 such as a camera and detects a foreign object, based on the obtained image.

FIGS. 3 and 4 are diagrams for describing a charging region detected by the image capturing device 30 of FIGS. 1 and 2.

Referring to FIGS. 3 and 4, the image capturing device 30 detects a charging region at an arbitrary angle, based on an arrangement structure of the transmitting coil and the receiving coil. In a method which detects a foreign object based on an image by using the image capturing device 30, because the image capturing device 30 detects a visible light region (visible light spectrum), there is a case where various lights (light of an adjacent vehicle, etc.) incident the charging region are reflected to a bottom or a case accommodating the transmitting/receiving coil.

Such reflected light functions as an undesired image difference value in a conventional detection method which detects a foreign object, based on a difference value between an image, including no foreign material prepared before performing wireless charging, and an image collected in the middle of charging, and thus, functions as a factor which increases a misdetection possibility of a foreign object, and due to this, degrades detection performance.

### SUMMARY

An aspect of the present disclosure is directed to providing a foreign object detection apparatus and an operating method thereof, which may photograph a charging region to obtain an image in a wireless charging system, may remove reflected light in the obtained image, and may detect a foreign object, based on an image from which the reflected light has been removed.

To achieve these and other advantages and in accordance with the purpose of the invention, as embodied and broadly described herein, there is provided an operating method of an apparatus for detecting foreign objects based on an image in a wireless charging system, the operating method including: a step of photographing a charging region of the wireless charging system to previously obtain a normal image including no foreign object by using an image capturing device; a step of photographing the charging region to obtain a current image of a current frame by using the image capturing device; a step of generating a difference image between the normal image and the current image by using an image processing device; a step of removing reflected light in the current image by using the image processing device; and a step of detecting whether a foreign object is in the charging region by using the image processing device, based on the difference image and a reflected light-removed current image.

In another aspect of the present invention, there is provided an apparatus for detecting foreign objects based on an image in a wireless charging system, the apparatus including: an image capturing device configured to photograph a charging region of the wireless charging system to previously obtain a normal image including no foreign object and photograph the charging region to a current image of a current frame; and an image processing device configured to generate a difference image between the normal image and the current image, remove reflected light in the current image, and detect whether a foreign object is in the charging region, based on the difference image and a reflected light-removed current image.

The image processing device may include: a processor configured to perform a process of generating an intersection image between the difference image and the reflected light-removed current image and a process of detecting whether the foreign object is in the charging region, based on the intersection image; and a memory configured to store instructions needed for performing the processes and output the instructions to the processor.

The image processing device may include: a processor configured to perform a process of generating an intersection image between the difference image and the reflected light-removed current image, a process of counting the number of pixels having a pixel value which is greater than or equal to a threshold value, in the intersection image, and a process of detecting whether the foreign object is in the charging region, based on the counted number of pixels; and a memory configured to store instructions needed for performing the processes and output the instructions to the processor.

The processor may compare the counted number of pixels with a reference number to obtain a comparison result and may detect whether the foreign object is in the charging region, based on the comparison result.

The image processing device may further include: a display device configured to, when the counted number of pixels is greater than the reference number, output the detection of the foreign object in the form of visual information; and an audio output device configured to output the detection of the foreign object in the form of auditory information.

The image processing device may include: a processor configured to perform a process of blurring a boundary line included in the current image by using a blurring operation, a process of removing the reflected light through a division operation of dividing a pixel value of the current image by a pixel value of a current image where the boundary line has been blurred, and a process of extending a boundary line of the reflected light-removed current image by using a morphological operation; and a memory configured to store instructions needed for performing the processes and output the instructions to the processor.

The blurring operation may include at least one of a Gaussian blur operation, an average blur operation, a median blur operation, and a bilateral filter operation.

The morphological operation may include a dilation operation.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure.

FIGS. 1 and 2 are diagrams for describing a wireless charging system of the related art.

FIGS. 3 and 4 are diagrams for describing a charging region detected by the image capturing device of FIGS. 1 and 2.

FIG. 5 is a block diagram of an apparatus for detecting foreign objects based on an image in a wireless charging system according to an embodiment of the present disclosure.

FIGS. 6 and 7 are flowcharts illustrating an operating method of an apparatus for detecting foreign objects based on an image in a wireless charging system according to an embodiment of the present disclosure.

FIG. 8 is a detailed flowchart of a process of removing reflected light in a current image in FIG. 6.

FIG. 9 illustrate exemplary images extracted in an operating process of an apparatus for detecting foreign objects based on an image in a wireless charging system according to an embodiment of the present disclosure.

FIGS. 10 and 11 are flowcharts illustrating an operating method of an apparatus for detecting foreign objects based on an image in a wireless charging system according to another embodiment of the present disclosure.

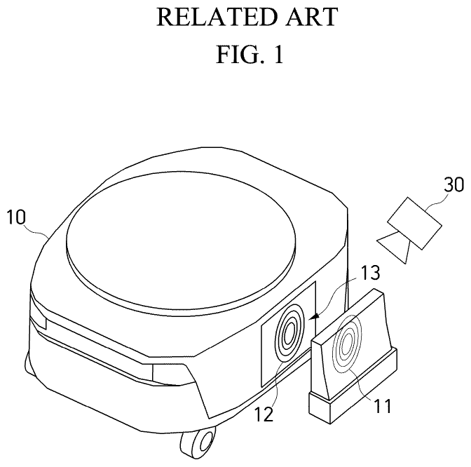

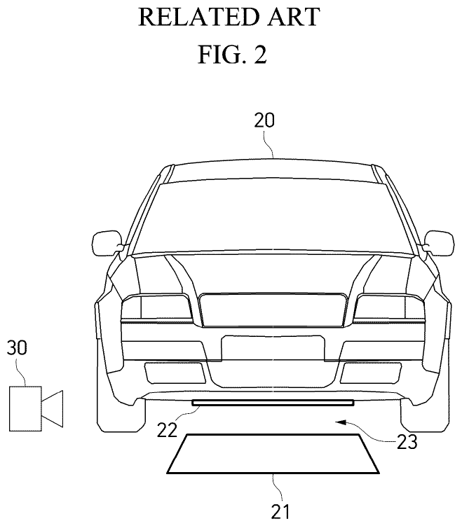

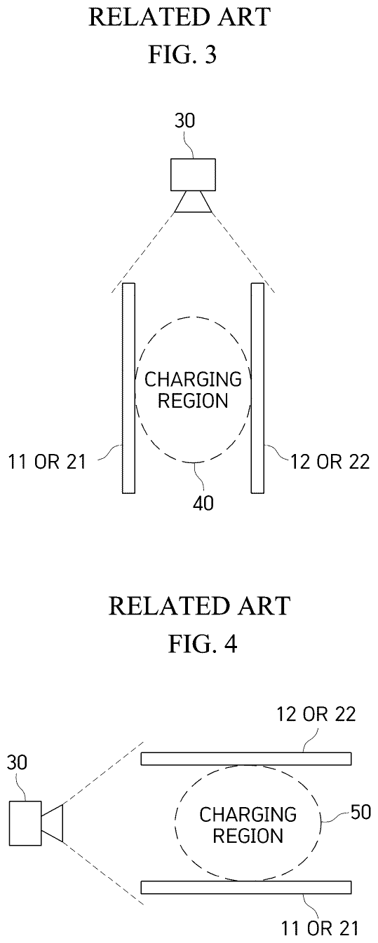

### DETAILED DESCRIPTION OF THE INVENTION

Reference will now be made in detail to the exemplary embodiments of the present disclosure, examples of which are illustrated in the accompanying drawings. Wherever possible, the same reference numbers will be used throughout the drawings to refer to the same or like parts.

In the following description, the technical terms are used only for explaining a specific embodiment while not limiting the present invention. The terms of a singular form may include plural forms unless referred to the contrary. The meaning of ‘comprise’, ‘include’, or ‘have’ specifies a property, a region, a fixed number, a step, a process, an element and/or a component but does not exclude other properties, regions, fixed numbers, steps, processes, elements and/or components.

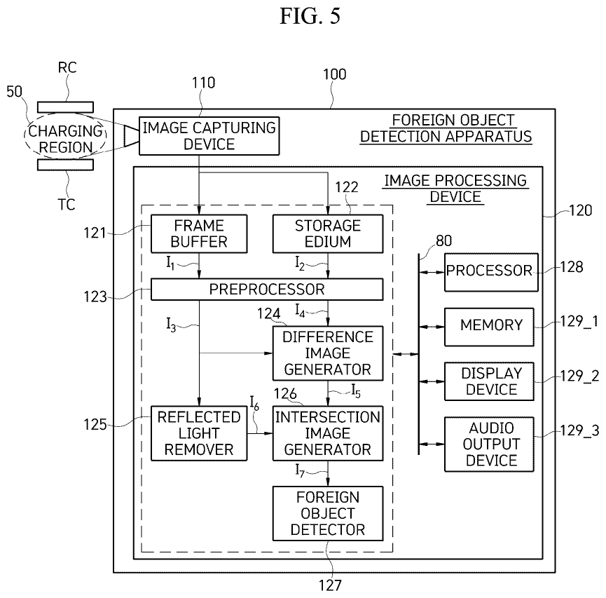

FIG. 5 is a block diagram of an apparatus 100 for detecting foreign objects based on an image in a wireless charging system according to an embodiment of the present disclosure.

Referring to FIG. 5, the apparatus 100 according to an embodiment of the present disclosure may be configured to detect whether a foreign object is in a charging region 50 representing a space between a transmitting coil TC and a receiving coil RC in the wireless charging system. To this end, the apparatus 100 may include an image capturing device 110 and an image processing device 120.

The image capturing device 110 may be a device which photographs the charging region 50, and for example, may be a camera. In an embodiment, the image capturing device 110 may photograph the charging region between the transmitting coil and the receiving coil in the wireless charging system to obtain a normal image including no foreign object and may store the obtained normal image in a storage medium 122. In an embodiment, the image capturing device 110 may photograph the charging region 50 to obtain an image by frame units. Hereinafter, an image of a current frame obtained by photographing the charging region 50 may be referred to as a ‘current image’. The image capturing device 110 may be connected to the image processing device 120 wirelessly or by cables and may transmit the normal image including no foreign object and the current image to the image processing device 120.

The image processing device 120 may be a device which detects whether a foreign object is in the charging region 50, based on the normal image and the current image, and may be implemented as a computing device. The computing device may be, for example, a desktop computer, a laptop computer, a smartphone, or a tablet computer.

In detail, the image processing device 120 may generate a difference image between the normal image and the current image and may remove reflected light in the current image, and then, may detect whether a foreign object is in the charging region 50, based on the difference image and the current image from which the reflected light has been removed.

To this end, the image processing device 120 may include a frame buffer 121, the storage medium 122, a preprocessor 123, a difference image generator 124, a reflected light remover 125, an intersection image generator 126, a foreign object detector 127, a processor 128, a memory 129_1, a display device 1292, and an audio output device 1293, but is not limited thereto and may further include other devices essential for implementing a computing device, and for example, may further include a communication device and an input device.

The frame buffer 121 may be a kind of memory which stores, by frame units, an image obtained by photographing the charging region 50 in real time with the image capturing device 110, and moreover, may store a current image I₁ and may load the current image I₁ to the below-described preprocessor 123.

The storage medium 122 may be a non-volatile memory device which stores a normal image I₂ which is obtained by previously photographing the charging region 50 with the image capturing device 110 and does not include a foreign object and may load the normal image I₂ including no foreign object to the preprocessor 123. The storage medium 122 may be implemented as, for example, a hard disk drive (HDD), a solid state drive (SSD), a non-volatile memory express (NVMe) SSD, or flash memory.

The preprocessor 123 may perform a preprocessing process of converting the current image I₁ and the normal image I₂, respectively loaded from the frame buffer 121 and the storage medium 122, into a binary image or a grayscale image.

The difference image generator 124 may generate a difference image I₅ between a preprocessed normal image 14 and a preprocessed current image I₃. Here, the difference image I₅ may denote an image which is generated by calculating a pixel value difference between the preprocessed normal image 14 and the preprocessed current image I₃.

The reflected light remover 125 may remove a reflected light component caused by an illumination effect of a charging region periphery in the preprocessed current image I₃ to generate a current image 16 from which reflected light has been removed. To remove reflected light in the preprocessed current image I₃, the reflected light remover 125 may first perform blurring of a boundary line included in the preprocessed current image I₃ by using a blurring operation. Here, the blurring operation may include at least one a Gaussian blur operation, an average blur operation, a median blur operation, and a bilateral filter operation. The Gaussian blur operation may be an operation of performing blurring of the boundary line by using a Gaussian distribution. The average blur operation may be an operation of performing blurring of the boundary line, based on an average of all pixel values in a kernel. The median blur operation may be an operation of performing blurring of the boundary line by using a median value of all pixel values in the kernel. Subsequently, the reflected light remover 125 may remove the reflected light through a division operation

$$“ \frac{{I}_{3}}{{I}_{3}^{′}} ”$$

of dividing a pixel value of the preprocessed current image I₃ by a pixel value of a current image I₃′ where the boundary line has been blurred. Subsequently, in order to obtain a maximum resolution in a process of generating an intersection image described below, the reflected light remover 125 may extend a boundary line of the reflected light-removed current image 16 by using a morphological operation. Here, a representative morphological operation may use, for example, a dilation operation.

The intersection image generator 126 may generate an intersection image 17 of the difference image I₅ generated by the difference image generator 124 and the reflected light-removed current image I₆ generated by the reflected light remover 125. Here, the intersection image I₇ may denote an image which represents a common portion of two images I₅ and I₆ or is obtained by emphasizing or visualizing an overlap region of two images I₅ and I₆. An AND operation on a pixel value of the difference image I₅ and a pixel value of the reflected light-removed current image I₆ may be used for generating the intersection image I₇.

The foreign object detector 127 may detect whether a foreign object is in the charging region 50, based on the intersection image I₇ generated by the intersection image generator 126. In an embodiment, the foreign object detector 127 may count the number of pixels having a pixel value which is greater than or equal to a threshold value, in the intersection image I₇, and may detect whether a foreign object is in the charging region 50, based on the counted number of pixels. In detail, the foreign object detector 127 may compare the counted number of pixels with a reference number to obtain a comparison result and may detect whether there is a foreign object penetrating into the charging region 50, based on the comparison result. For example, when the counted number of pixels is greater than the reference number, the foreign object detector 127 may determine that the foreign object is the charging region 50.

The processor 128 may be a device which is connected to the above-described blocks 121 to 127 through a system bus 80 and controls operations and/or executions of the blocks 121 to 127, and for example, may include at least one central processing unit (CPU) and at least one graphics processing unit (GPU), or may be implemented as a microcontroller unit (MCU) or a system on chip (SoC) including the CPU and the GPU.

The memory 1291 may be a device which stores instructions needed for operating and/or executing a process performed by each of the above-described blocks 121 to 127 and may output the instructions to the processor 128, based on a request of the processor 128.

The display device 129_2 and the audio output device 129_3 may each be a device which warns about the detection of a foreign object when it is detected by the foreign object detector 127 that the foreign object is in the charging region. The display device 129_2 may output the detection of the foreign object in the form of visual information, and for example, may be implemented as a liquid crystal display (LCD) or an organic light emitting diode (OLED). The audio output device 1293 may output the detection of the foreign object in the form of auditory information, and for example, may be implemented as a speaker.

Furthermore, the above-described blocks 123 to 127 may each be implemented as a software module or a program, and in this case, a main element of a process performed in each block may be the processor 128. Accordingly, the blocks 123 to 127 described above with reference to FIG. 5 may be replaced with one processor 128.

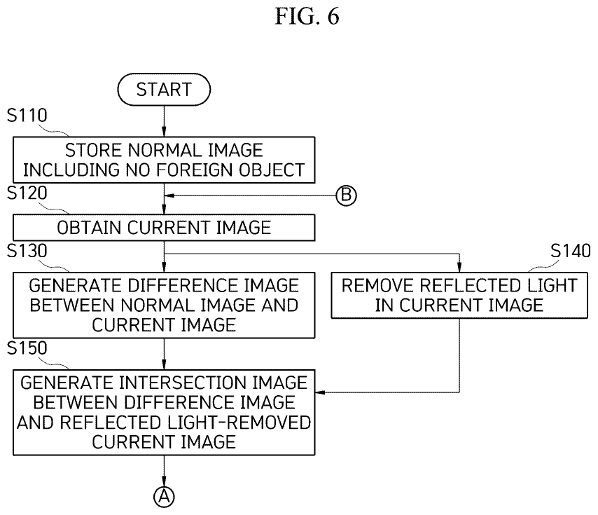

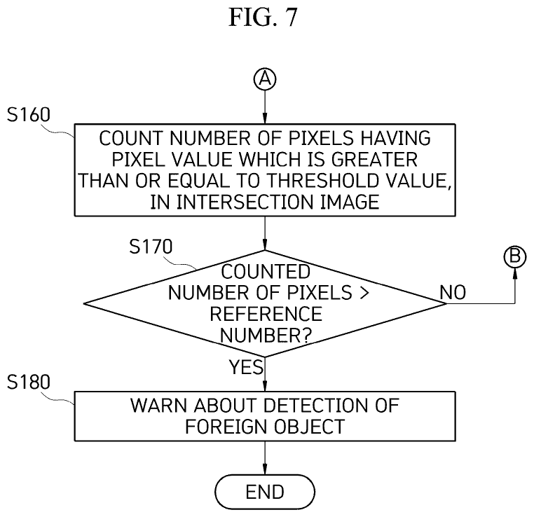

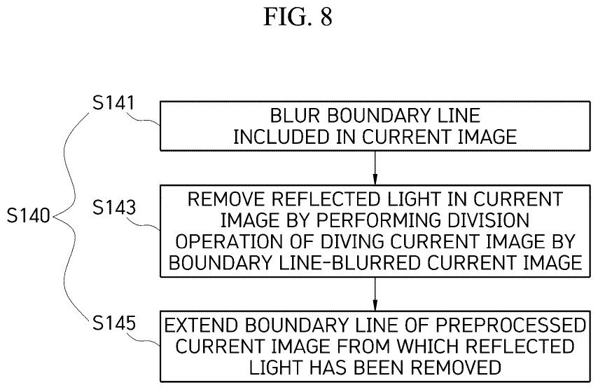

FIGS. 6 and 7 are flowcharts illustrating an operating method of an apparatus for detecting foreign objects based on an image in a wireless charging system according to an embodiment of the present disclosure. FIG. 8 is a detailed flowchart of a process of removing reflected light in a current image in FIG. 6.

In describing an operating method of the apparatus 100 according to the present disclosure, for conciseness of description, a preprocessing process performed by the preprocessor 123 of FIG. 5 may be omitted below.

First, referring to FIGS. 6 and 7, in step S110, the image capturing device 110 may photograph the charging region 50 of the wireless charging system to previously obtain a normal image including no foreign object and may store the normal image in the storage medium 122.

Subsequently, in step S120, the image capturing device 110 may photograph the charging region 50 to obtain a current image of a current frame.

Subsequently, in step S130, the image processing device 120, the difference image generator 124, or the processor 128 may generate the difference image I₅ between the normal image 14 and the current image I₃.

Subsequently, in step S140, the image processing device 120, the reflected light remover 125, or the processor 128 may remove reflected light in the current image 13.

Subsequently, in steps S150 to S180, the image processing device 120 may detect whether a foreign object is in the charging region 50, based on the difference image I₅ and the reflected light-removed current image I₆.

In detail, in step S150, the image processing device 120, the intersection image generator 126, or the processor 128 may generate the intersection image I₇ between the difference image I₅ and the reflected light-removed current image 16.

Subsequently, in step S160, the image processing device 120, the foreign object detector 127, or the processor 128 may count the number of pixels having a pixel value which is greater than or equal to a threshold value, in the intersection image I₇.

Subsequently, in step S170, the image processing device 120, the foreign object detector 127, or the processor 128 may compare the counted number of pixels with the reference number. When the counted number of pixels is greater than the reference number, the image processing device 120, the foreign object detector 127, or the processor 128 may move to step S180, and otherwise, may return to step S120.

Subsequently, in step S180, when the counted number of pixels is greater than the reference number, the image processing device 120, the foreign object detector 127, or the processor 128 may warn about the detection of the foreign object. In this case, foreign object detection warning may be performed by the display device 129_2 and/or the audio output device 129_3.

Referring to FIG. 8, a step of removing reflected light in the current image I₃ may include step S141 of blurring a boundary line included in the current image by using a blurring operation, step S143 of removing the reflected light through a division operation of dividing a pixel value of the current image by a pixel value of a current image where the boundary line has been blurred, and step S145 of extending a boundary line of the reflected light-removed current image by using a morphological operation. Here, the blurring operation may include at least one a Gaussian blur operation, an average blur operation, a median blur operation, and a bilateral filter operation. Also, the morphological operation may use a dilation operation. The dilation operation, which is a kind of morphological operation, may be a kind of technology which is widely used in image processing field, and thus, detailed descriptions below may be replaced with known technology.

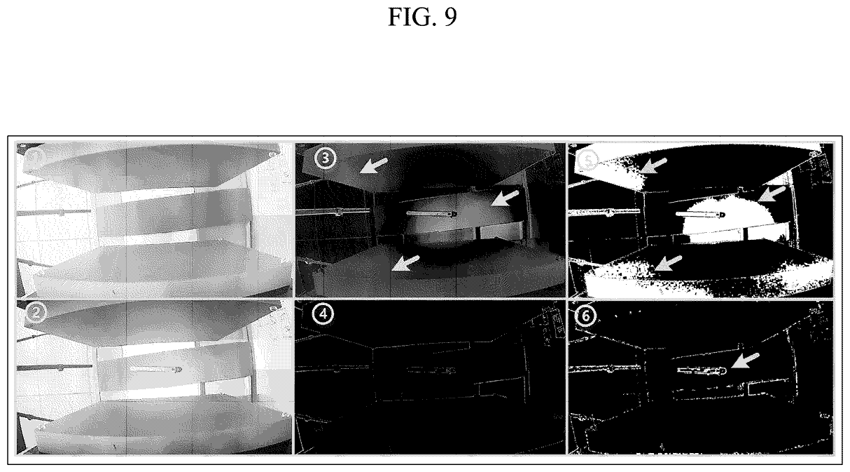

FIG. 9 illustrate exemplary images extracted in an operating process of an apparatus for detecting foreign objects based on an image in a wireless charging system according to an embodiment of the present disclosure.

Referring to FIG. 9, image No. 1 \textcircled{1} may be an image including no foreign object, and image No. 2 \textcircled{2} may be a current image of a current frame. Two images \textcircled{1} and \textcircled{2} may be converted into a black-and-white image (a binary image), and then, a difference image between two images \textcircled{1} and \textcircled{2} converted into the black-and-white image may be image No. 3 \textcircled{3}. In the image No. 3 \textcircled{3}, a portion indicated by an arrow may be a portion where reflected light appears.

An image, which is used for detecting a foreign object by using only the difference image \textcircled{3} without removing the reflected light, may be image No. 5 \textcircled{5}. In the image No. 5 \textcircled{5}, a portion indicated by an arrow may be a portion which is a reflected light region, and the reflected light region may function as a factor which causes the misdetection of a foreign material.

To remove the reflected light region, reflected light may be removed in the image No. 2 \textcircled{2} converted into the black-and-white image through the reflected light removing process (S140 of FIGS. 6 and 8) described above, and an image obtained by detecting a boundary line in reflected light-removed image No. 4 \textcircled{4} may be image No. 4 \textcircled{4}.

An intersection image between the image No. 3 \textcircled{3} representing a difference image and the reflected light-removed image No. 4 \textcircled{4} may be image No. 6 \textcircled{6}. In the image No. 6 \textcircled{6}, it may be seen that the most of reflected light is removed. In the image No. 6 \textcircled{6}, a region indicated by an arrow may be a region including a foreign object. In the image No. 6 \textcircled{6}, the number of pixels having a pixel value which is greater than a threshold voltage may be counted, and the detection of a foreign object may be performed based on the counted number of pixels.

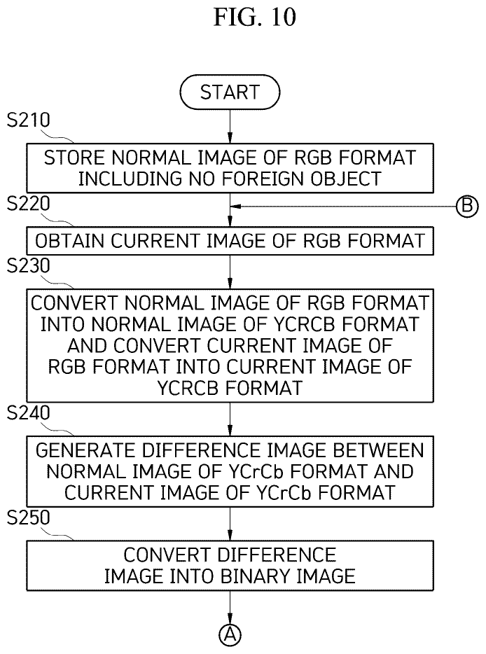

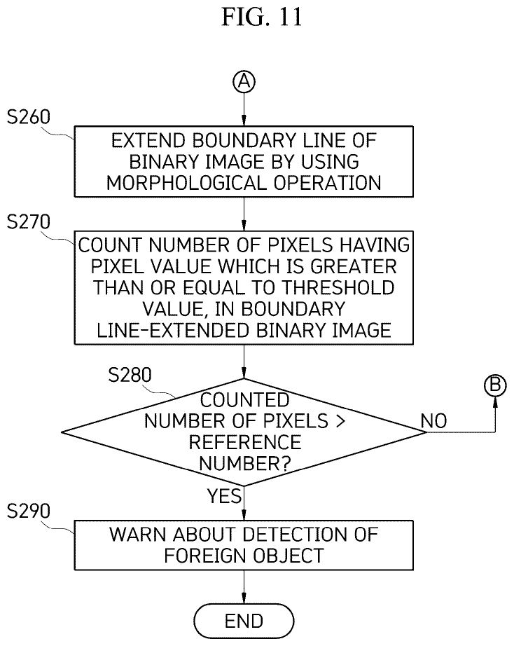

FIGS. 10 and 11 are flowcharts illustrating an operating method of an apparatus for detecting foreign objects based on an image in a wireless charging system according to another embodiment of the present disclosure.

Referring to FIG. 10, first, in step S210, the image capturing device 110 may previously photograph the charging region 50 including no foreign object to obtain a normal image of RGB format including no foreign object and may store the normal image in the storage medium 122. Here, the normal image of RGB format may denote an image which is expressed in an RGB color space.

Subsequently, in step S220, the image capturing device 110 may photograph the charging region 50 in real time to obtain a current image of RGB format by frame units and may store the current image in the frame buffer 121.

Subsequently, in step S230, the processor 126 or the preprocessor 123 of the image processing device 120 may convert the normal image of RGB format into a normal image of YCrCb format and may convert the current image of RGB format into a current image of YCrCb format. An image of YCrCb format may denote an image which is expressed in a YCrCb color space. For example, a color space conversion algorithm may be used for converting an image of RGB format into an image of YCrCb format. In another embodiment of the present disclosure, a foreign object may be detected by converting an image of RGB format into an image of YCbCr format, and thus, it may be possible to detect a foreign object insensitive to luminance conversion. In YCrCb, Y may be associated with luminance information, Cr may be an abbreviation of chrominance red and may be associated with red information, and Cb may be an abbreviation of chrominance blue and may be associated with blue information. In this case, when a Y component associated with luminance information is removed in an image, and Cb and Cr components are used to determine whether a foreign object is detected, illumination noise such as reflected light may be removed.

Subsequently, in step S240, the difference image generator 124 or the processor 128 of the image processing device 120 may generate a difference image between the normal image of YCrCb format and the current image of YCrCb format, based on control and/or execution thereof. In the difference image generating step S130 of FIG. 6, the difference image may be generated based on a binary image or a grayscale image. The binary image or the grayscale image may include luminance information, and thus, may be sensitive to noise such as reflected light. In another embodiment of the present disclosure, because a difference image is generated based on an image of format insensitive to YCbCr luminance conversion, a difference image robust to noise such as reflected light may be generated.

Subsequently, in step S250, the preprocessor 123 or the processor 128 of the image processing device 120 may convert the difference image of YCbCr format into a binary image or a grayscale image, based on control and/or execution thereof. Hereinafter, it may be assumed that a difference image of YCbCr format is converted into a binary image.

Subsequently, referring to FIG. 11, in step S260, the processor 128 of the image processing device 120 may extend a boundary line of a binary image by using a morphological operation (for example, a dilation operation).

Subsequently, in step S270, the foreign object detector 127 or the processor 128 of the image processing device 120 may count the number of pixels having a pixel value which is greater than or equal to a threshold value in a binary image where a boundary line thereof extends, based on control and/or execution thereof.

Subsequently, in step S280, the foreign object detector 127 or the processor 128 of the image processing device 120 may compare the counted number of pixels with a reference number, based on control and/or execution thereof, and when the counted number of pixels is greater than the reference number, the display device 129_2 and/or the audio output device 1293 may warn about the detection of a foreign object in the form of visual information and/or auditory information in step S290. For example, when the counted number of pixels is less than or equal to the reference number, the image processing device 120 may return to step S220 and may repeatedly perform steps S220 to S270.

According to the embodiments of the present disclosure, as reflected light is removed in an image obtained by photographing a charging region of a wireless charging system, the misdetection of a foreign object may be reduced, and the foreign object may be detected through a simple image processing operation, and thus, a foreign object may be detected in real time in low-specification devices.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. An operating method of an apparatus for detecting foreign objects based on an image in a wireless charging system, the operating method comprising:
a step of photographing a charging region of the wireless charging system to previously obtain a normal image including no foreign object by using an image capturing device;
a step of photographing the charging region to obtain a current image of a current frame by using the image capturing device;
a step of generating a difference image between the normal image and the current image by using an image processing device;
a step of removing reflected light in the current image by using the image processing device; and
a step of detecting whether a foreign object is in the charging region by using the image processing device, based on the difference image and a reflected light-removed current image.

2. The operating method of claim 1, wherein the step of detecting whether the foreign object is in the charging region comprises:
a step of generating an intersection image between the difference image and the reflected light-removed current image; and
a step of detecting whether the foreign object is in the charging region, based on the intersection image.

3. The operating method of claim 1, wherein the step of detecting whether the foreign object is in the charging region comprises:
a step of generating an intersection image between the difference image and the reflected light-removed current image;
a step of counting the number of pixels having a pixel value which is greater than or equal to a threshold value, in the intersection image; and
a step of detecting whether the foreign object is in the charging region, based on the counted number of pixels.

4. The operating method of claim 3, wherein the step of detecting whether the foreign object is in the charging region comprises a step of comparing the counted number of pixels with a reference number to obtain a comparison result and detecting whether the foreign object is in the charging region, based on the comparison result.

5. The operating method of claim 3, further comprising a step of, when the counted number of pixels is greater than a reference number, warning about the detection of the foreign object by using at least one of a display device and an audio output device.

6. The operating method of claim 1, wherein the step of removing the reflected light in the current image comprises:
a step of blurring a boundary line included in the current image by using a blurring operation;
a step of removing the reflected light through a division operation of dividing a pixel value of the current image by a pixel value of a current image where the boundary line has been blurred; and
a step of extending a boundary line of the reflected light-removed current image by using a morphological operation.

7. The operating method of claim 6, wherein the blurring operation comprises at least one of a Gaussian blur operation, an average blur operation, a median blur operation, and a bilateral filter operation.

8. The operating method of claim 6, wherein the morphological operation comprises a dilation operation.

9. An apparatus for detecting foreign objects based on an image in a wireless charging system, the apparatus comprising:
an image capturing device configured to photograph a charging region of the wireless charging system to previously obtain a normal image including no foreign object and photograph the charging region to a current image of a current frame; and
an image processing device configured to generate a difference image between the normal image and the current image, remove reflected light in the current image, and detect whether a foreign object is in the charging region, based on the difference image and a reflected light-removed current image.

10. The apparatus of claim 9, wherein the image processing device comprises:
a processor configured to perform a process of generating an intersection image between the difference image and the reflected light-removed current image and a process of detecting whether the foreign object is in the charging region, based on the intersection image; and
a memory configured to store instructions needed for performing the processes and output the instructions to the processor.

11. The apparatus of claim 9, wherein the image processing device comprises:
a processor configured to perform a process of generating an intersection image between the difference image and the reflected light-removed current image, a process of counting the number of pixels having a pixel value which is greater than or equal to a threshold value, in the intersection image, and a process of detecting whether the foreign object is in the charging region, based on the counted number of pixels; and
a memory configured to store instructions needed for performing the processes and output the instructions to the processor.

12. The apparatus of claim 11, wherein the processor compares the counted number of pixels with a reference number to obtain a comparison result and detects whether the foreign object is in the charging region, based on the comparison result.

13. The apparatus of claim 11, wherein the image processing device further comprises:
a display device configured to, when the counted number of pixels is greater than the reference number, output the detection of the foreign object in the form of visual information; and
an audio output device configured to output the detection of the foreign object in the form of auditory information.

14. The apparatus of claim 9, wherein the image processing device comprises:
a processor configured to perform a process of blurring a boundary line included in the current image by using a blurring operation, a process of removing the reflected light through a division operation of dividing a pixel value of the current image by a pixel value of a current image where the boundary line has been blurred, and a process of extending a boundary line of the reflected light-removed current image by using a morphological operation; and
a memory configured to store instructions needed for performing the processes and output the instructions to the processor.

15. The apparatus of claim 14, wherein the blurring operation comprises at least one of a Gaussian blur operation, an average blur operation, a median blur operation, and a bilateral filter operation.

16. The apparatus of claim 14, wherein the morphological operation comprises a dilation operation.

17. An operating method of an apparatus for detecting foreign objects based on an image in a wireless charging system, the operating method comprising:
a step of photographing a charging region of the wireless charging system to previously obtain a normal image of RGB format including no foreign object by using an image capturing device;
a step of photographing the charging region to obtain a current image of RGB format of a current frame by using the image capturing device;
a step of converting the normal image of RGB format into a normal image of YCrCb format and converting the current image of RGB format into a current image of YCrCb format by using an image processing device;
a step of generating a difference image between the normal image of YCrCb format and the current image of YCrCb format by using the image processing device;
a step of converting the difference image into a binary image by using the image processing device; and
a step of detecting whether a foreign object is in the charging region by using the image processing device, based on the binary image.

18. The operating method of claim 17, further comprising,
between the step of converting the difference image into the binary image and the step of detecting whether the foreign object is in the charging region,
a step of extending a boundary line of the binary image by using the image processing device, based on a morphological operation.

19. The operating method of claim 17, wherein the step of detecting whether the foreign object is in the charging region comprises:
a step of counting the number of pixels having a pixel value which is greater than or equal to a threshold value, in the binary image; and
a step of comparing the counted number of pixels with a reference number to detect whether the foreign object is in the charging region.

20. The operating method of claim 19, wherein the step of comparing the counted number of pixels with a reference number to detect whether the foreign object is in the charging region comprises a step of, when the counted number of pixels is greater than the reference number, determining that the foreign object is in the charging region.
